(19) United States
(12) Patent Application Publication
(10) Pub. No.: US 2008/0061197 A1
(43) Pub. Date: Mar. 13, 2008

(54) Universal detachable presentation bracket

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 11/519,457

(22) Filed: Sep. 11, 2006

(51) Int. Cl. F16M 11/02

(52) U.S. Cl. 248/181.1

(57) ABSTRACT

A novel universal detachable presentation bracket that is universally positionable by operating in a spherical coordinate system, and method for positionally adjusting a presentation device on the bracket within the spherical coordinate frame. According to one aspect of the invention the novel universal detachable presentation bracket is provided by two releasably interlockable rotationally and spherically rotatable ball-and-socket components that are formed between a substantially rigid spacing component and two part-spherical couplers. A suction cup clamp mechanism is coupled to one of the two part-spherical couplers, and a retention being coupled to a different one of the two part-spherical couplers.

This application is related to co-pending patent application Ser. No. ______ “Sheet Music Stand” (Attorney Docket No. NPI-060) and Ser. No. ______ “Universal Pole Caddy” (Attorney Docket No. NPI-061) both filed in the name of the same inventor on the same day herewith, which are both incorporated herein by reference.

### FIELD OF THE INVENTION

The present invention relates generally to a bracket for holding a presentation device or other useful device, and more particularly to a bracket particularly suitable to be detachably carried on the body of a musical instrument or another smooth and substantially planar surface.

### BACKGROUND OF THE INVENTION

Detachable presentation brackets, and particularly music stands for holding sheet music, are generally well-known and have an advantage in being easily positioned relative to the user. For example, detachable music stands are generally well-known having the advantage of being conveniently carried on the body of an instrument while the instrument is played.

However, known detachable presentation brackets have been limited to positional adjustments within a rectangular coordinate frame by independent adjustments of rigid arms slidingly operable along different orthogonal X, Y and Z coordinate axes. Alternatively, some other detachable presentation brackets are limited to positional adjustments within a cylindrical coordinate frame by including a rotationally adjustable arm component that is radially slidable.

Detachable music stands in particular have been limited to date to use with a specific species of musical instrument, such as a guitar, or even more limited to use with a subspecies, such as acoustic guitar. Known detachable music stands have also been limited in positional adjustment, as discussed herein above. In particular, detachable music stands have been limited in their ability to adequately position the sheet music for the musician to read while playing.

Accordingly, known detachable presentation brackets are cumbersome to operate, and positioning of the presentation device is limited. In particular known detachable music stands, are cumbersome to operate, and positioning sheet music is inefficient and inexact.

### SUMMARY OF THE INVENTION

The present invention overcomes the limitations of the prior art by providing a novel presentation bracket for positioning a presentation device or other device within a spherical coordinate system. According to one embodiment of the invention, the novel presentation bracket presents a detachable retention device that is structured for supporting or holding external objects thereon or therein and is universally positionable by operating the novel presentation bracket within a spherical coordinate system.

Accordingly, the present invention universal detachable presentation bracket that provides positional adjustments of an attached device within a spherical coordinate frame. The presentation bracket provides first and second part-spherical couplers each formed of a resiliently deformable material having a substantially smooth part spherical outer surface and being projected from a flange on a substantially rigid stem, and a substantially rigid spacing component formed of a pair of substantially rigid arm sections forming first and second pairs of sockets adjacent to opposite ends thereof, each of the first and second pairs of arm sections being formed with substantially smooth and rigid concave interior surfaces shaped to substantially conform to the part spherical outer surface portion of the respective first and second resiliently deformable part-spherical couplers. An adjustable clamping mechanism is operable with the spacing component for urging the first and second pairs of sockets of the two substantially rigid arm sections into each of three sequential adjustment relationships to the respective first and second part-spherical couplers. The three sequential adjustment relationships are: a first loosely clamped relationship forming first and second relatively rotatable ball-and-socket joints between the first and second pairs of sockets and the part spherical outer surface portions of the respective first and second part-spherical couplers, a second partially clamped relationship securely interlocking the first pair of sockets with the part spherical outer surface portion of the first part-spherical coupler, while retaining the second relatively rotatable ball-and-socket joint between the second pair of sockets and the part spherical outer surface portions of the second part-spherical coupler, and a third fully clamped relationship securely interlocking the first and second pairs of sockets with the part spherical outer surface portions of the respective first and second part-spherical couplers. A suction cup clamp mechanism is coupled to one of the two part-spherical couplers, and a retention device is coupled to a different one of the two part-spherical couplers. According to one embodiment of the invention, the retention device is a caddy, such as a paper sheet or book support member or other clip board for retaining sheet music or other papers or books. Alternatively, the caddy retention device is a conventional cup-type holder for holding an individual serving can or bottle drink container, e.g., a common 12 ounce soda can Alternatively, the caddy retention device includes a substantially rigid metal, plastic or polycarbonate frame having a cup-type can or bottle drink container holder or other can or bottle drink container holder, and another useful device, such as a tray, e.g., a candy or ash tray.

According to one embodiment of the invention, a differential biasing mechanism is coupled between the arm sections of the spacing component for differentially urging apart one of the first and second pairs of sockets, and simultaneously urging together a different one of the first and second pairs of sockets.

According to another aspect of the invention, the presentation bracket of the invention further includes a coupler bracket intervening between the attached device and the part-spherical coupler. By example and without limitation, the intervening coupler bracket is formed of a flange having a rigid stem projected from a first surface thereof and being necked-down to be smaller than the part-spherical coupler, and a mounting platform formed on a second surface thereof opposite from the stem. The part-spherical coupler is coupled to the stem in a position spaced away from the flange.

According to another aspect of the invention, the present invention provides a method for positionally adjusting a universal detachable presentation bracket within a spherical coordinate frame. The method of the invention includes, on respective substantially rigid neck portions, projecting each of two part-spherical couplers from respective flange members; coupling the flange member of one of the two part-spherical couplers to a suction cup clamp mechanism, coupling the flange member of a different one of the two part-spherical couplers to a retention device or other support member; in opposite ends of a substantially rigid spacing component, forming pairs of sockets complementary to respective ones of the two part-spherical couplers; operating an adjustable clamping mechanism for forming respective rotationally and spherically rotatable ball-and-socket components between the two part-spherical couplers and respective ones of the two pairs of complementary sockets; spherically rotating one or both of the two part-spherical couplers within the two corresponding pairs of complementary sockets relative to the substantially rigid spacing component for spherically and rotationally adjusting a position and orientation of the sheet music support member relative to the suction cup clamp mechanism; and subsequently operating the adjustable clamping mechanism for immobilizing both of the two ball-and-socket components.

According to another aspect of the invention, the method of the invention further includes operating the adjustable clamping mechanism for forming one of the rotationally and spherically rotatable ball-and-socket components between one of the two part-spherical couplers and the respective one of the two pairs of complementary sockets, and substantially simultaneously operating the adjustable clamping mechanism for immobilizing a different one of the two ball-and-socket components.

According to another aspect of the invention, the method of the invention further includes forming each of the two part-spherical couplers of a resiliently deformable material having a substantially smooth part spherical outer surface. Here, the step of forming pairs of sockets complementary to respective ones of the two part-spherical couplers further includes forming the two pairs of complementary sockets having substantially smooth and rigid concave interior surfaces shaped to substantially conform to the part spherical outer surface portion of a corresponding one of the resiliently deformable part-spherical couplers.

According to another aspect of the invention, the method of the invention further includes positioning a resilient differential biasing mechanism for differentially urging apart one of the two pairs of complementary sockets, and substantially simultaneously urging together a different one of the two ball-and-socket components.

According to still another aspect of the invention, the method of the invention further includes coupling the suction cup clamp mechanism to a substantially smooth external surface, and then supporting one or more papers on the support member. Alternatively, according to another aspect of the invention, the method of the invention further includes instead supporting a conventional drink holder container on the support member.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an example of the universal detachable presentation bracket of the invention embodied as a detachable music stand;

FIG. 2 is another perspective view showing an example of the universal detachable presentation bracket of the invention embodied as a detachable music stand;

FIG. 3 is an assembly view that illustrates the different components of the universal detachable presentation bracket of the invention embodied as a detachable music stand;

FIG. 4 is another assembly view that illustrates the different components of the universal detachable presentation bracket of the invention embodied as a general device mount;

FIG. 5 is another assembly view that illustrates the different components of the universal detachable presentation bracket of the invention embodied as another general device mount; and

FIG. 6 is another assembly view that illustrates the different components of the universal detachable presentation bracket of the invention embodied as yet another general device mount.

### DETAILED DESCRIPTION OF PREFERRED EMBODIMENT

In the Figures, like numerals indicate like elements.

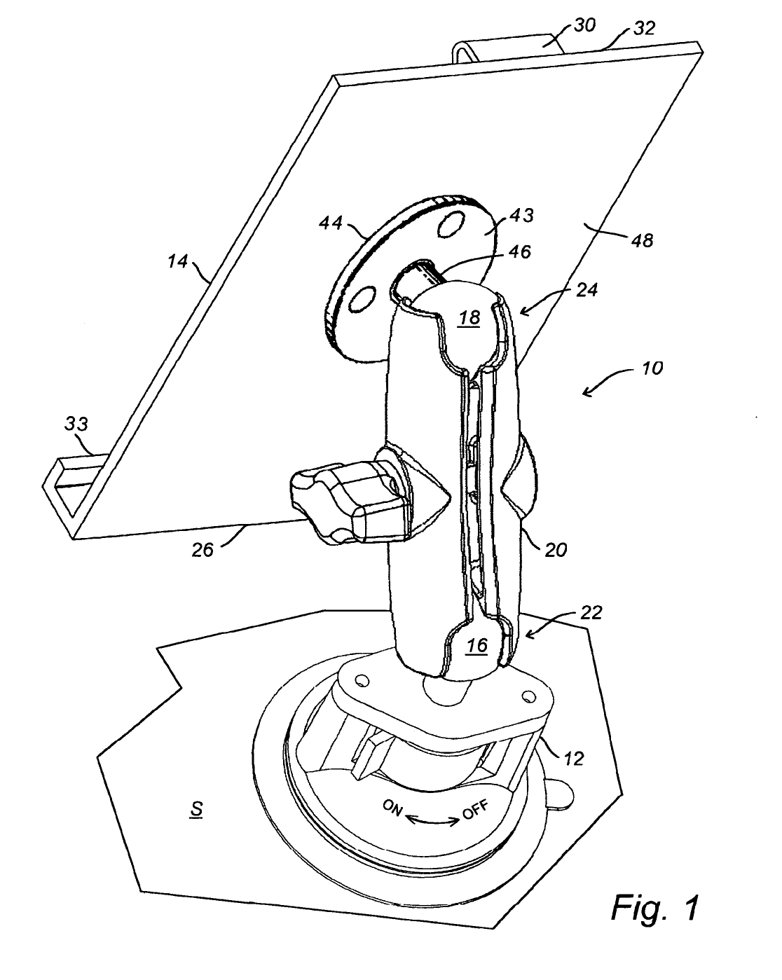

FIG. 1 is a perspective view that illustrates the universal detachable presentation bracket 10 of the present invention embodied by example and without limitation as a universal detachable sheet music stand that provides positional adjustments within a spherical coordinate frame by two rotationally and spherically adjustable ball-and-socket components spaced apart on a single spacing component. The universal detachable presentation bracket 10 of the present invention is structured as a music stand for detachable attachment to any musical instrument having a substantially smooth and reasonably planar surface of even minimal area capable of securely receiving a suction cup. By example and without limitation, the universal detachable presentation bracket 10 of the invention readily mounts to the sound board of a stringed instrument, such as an acoustic or electronic guitar, banjo or cello, for holding sheet music in a position that is convenient to the musician while playing. The universal detachable music presentation bracket 10 of the invention also readily mounts to the casing of a keyboard instrument, such as a piano, organ or electronic keyboard, yet also accommodates the shell wall of percussion instrument, for example, a drum or xylophone. Alternatively, the universal detachable presentation bracket 10 of the invention is mounted to another substantially planar surface, such as an automobile windshield for example for holding other papers rather than sheet music, or a bathtub wall for example for holding a shaving mirror, or a wall or window for holding a drink container.

Accordingly, the universal detachable presentation bracket 10 of the invention includes a suction cup clamp 12 and a retention device 14 structured for supporting or holding external objects thereon or therein. When presentation bracket 10 of the invention is embodied as a detachable music stand, the retention device 14 is structured by example and without limitation as a universal music sheet or book support member or other clip board for retaining sheet music or other papers or books. Each of the suction cup clamp 12 and clip board 14 are configured having a respective attached part-spherical coupler 16, 18. A double-socket spacing mechanism 20 extends between and joins the two part-spherical couplers 16, 18 in a pair of spaced-apart ball-and-socket joints 22, 24, respectively. Both of the ball-and-socket joints 22, 24 are both rotationally and spherically adjustable relative to the intervening spacing mechanism 20. Accordingly, the universal detachable presentation bracket 10 of the invention provides positional adjustments of the universal support member or clip board 14 relative to the suction cup clamp 12 within a spherical coordinate frame.

By example and without limitation, the double-socket spacing mechanism 20 is operable in a first loosely clamped state for forming first and second spaced-apart and relatively rotatable ball-and-socket joints 22, 24 with the two part-spherical couplers 16, 18. The double-socket spacing mechanism 20 is also operable in a second partially clamped state for securely interlocking with the spacing mechanism 20 with an outer surface of the first part-spherical coupler 16, while retaining the second relatively rotatable ball-and-socket joint 24 with the second part-spherical coupler 18. The double-socket spacing mechanism 20 is further operable in a third fully clamped state for securely interlocking the spacing mechanism 20 with both of the two part-spherical couplers 16, 18. Therefore, with the suction cup clamp 12 securely attached to a selected substantially smooth and generally planar surface S, the double-socket spacing mechanism 20 is operated in the first loosely clamped state for forming the two relatively rotatable ball-and-socket joints 22, 24 with the two part-spherical couplers 16, 18 so that the double-socket spacing mechanism 20 can be rotated about both of the two part-spherical couplers 16, 18 in any orientation within range of the device. Next, with the suction cup clamp 12 still securely attached to the selected surface S, the double-socket spacing mechanism 20 is operated in the second partially clamped together state for securely interlocking with the spacing mechanism 20 with the first part-spherical coupler 16 on the securely attached suction cup clamp 12, while the second relatively rotatable ball-and-socket joint 24 is retained with the second part-spherical coupler 18. Thus, the spacing mechanism 20 is securely clamped in a selected orientation with the suction cup clamp 12 and the selected surface S, while the clip board 14 is still rotatable about the second relatively rotatable ball-and-socket joint 24 formed between the spacing mechanism 20 and the second part-spherical coupler 18. When the clip board 14 is rotated into the selected spherical position and orientation relative to the suction cup clamp 12 and the selected surface S, the double-socket spacing mechanism 20 is operated in the third fully clamped state for securely interlocking the spacing mechanism 20 with both of the two part-spherical couplers 16, 18. Thereafter, the spacing mechanism 20 is securely interlocked with the two part-spherical couplers 16, 18, and through them interlocks the clip board 14 with the suction cup clamp 12 and the selected surface S, whereby the clip board 14 is immovably secured in the selected spherical position and orientation. Sheet music or can be attached to the clip board 14 in a position that is convenient to the musician while playing. Alternatively, other papers are attached to the clip board 14 in a position that is convenient to the user.

Partial loosening causes the spacing mechanism 20 to retreat from the third clamped fully clamped state to the second partially clamped state, wherein the spacing mechanism 20 reforms the second relatively rotatable ball-and-socket joint 24 with the second part-spherical coupler 18, but remains securely interlocked to the first part-spherical coupler 16 on the suction cup clamp 12. Thus, the clip board 14 is easily reoriented and repositioned spherically relative to the securely interlocked spacing mechanism 20, the suction cup clamp 12 and the selected surface S, without changing the spherical orientation of the spacing mechanism 20 relative to the suction cup clamp 12.

Additional loosening causes the spacing mechanism 20 to retreat from the second partially clamped state to the first loosely clamped state, wherein the spacing mechanism 20 continues to form the second relatively rotatable ball-and-socket joint 24 with the second part-spherical coupler 18, and additionally reforms the first relatively rotatable ball-and-socket joint 22 with the first part-spherical coupler 16. Thus, the clip board 14 remains easily spherically reorientable and repositionable relative to the spacing mechanism 20, and the spacing mechanism 20 is easily spherically reoriented and repositioned relative to the suction cup clamp 12 which is still securely attached to the selected surface S.

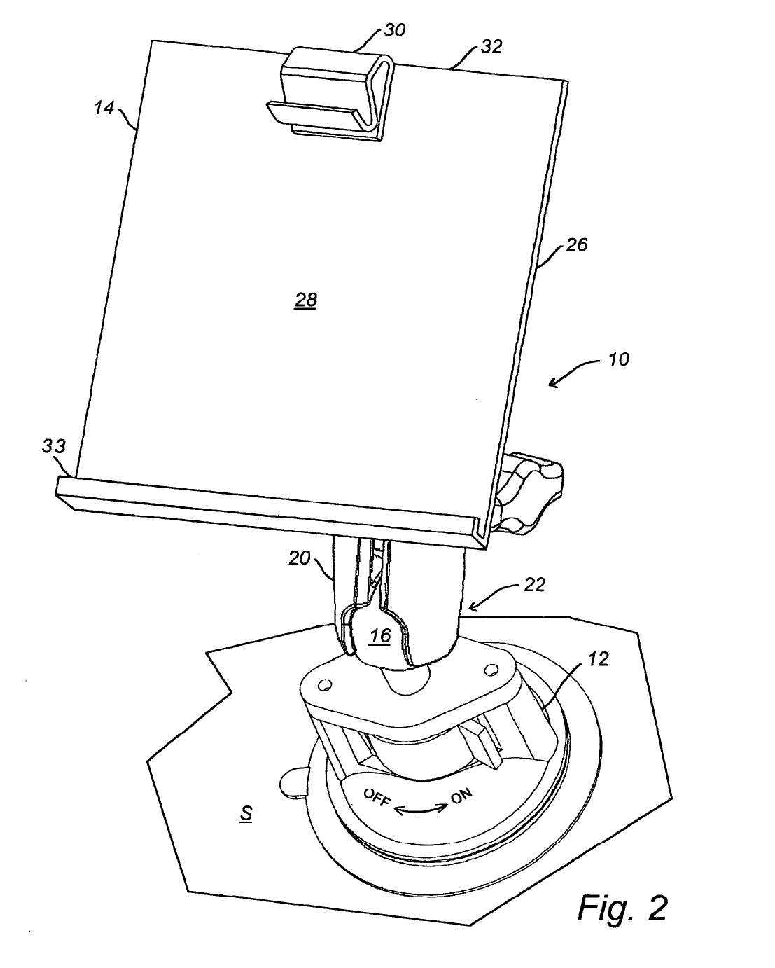

FIG. 2 is another perspective view that also illustrates the universal detachable presentation bracket 10 of the invention embodied by example and without limitation as a universal detachable music stand that is structured for attachment to any musical instrument having a surface area capable of securely receiving a suction cup. Here, the clip board 14 is illustrated as a conventional clip board having a thin, substantially rigid board 26 with a reasonably flat work or support surface 28 which may be generally rectangular. By example and without limitation, a spring clip 30 is attached adjacent to one edge 32 of the board 26, either one of the short edges (shown) or alternatively one of the long edges, for holding sheet music or other papers. Other means for holding sheet music papers to the work surface 28 are also contemplated and may be substituted for the spring clip 30 without departing from the spirit and scope of the invention. For example, a shelf 33 is optionally provided for holding sheet music or other books or papers.

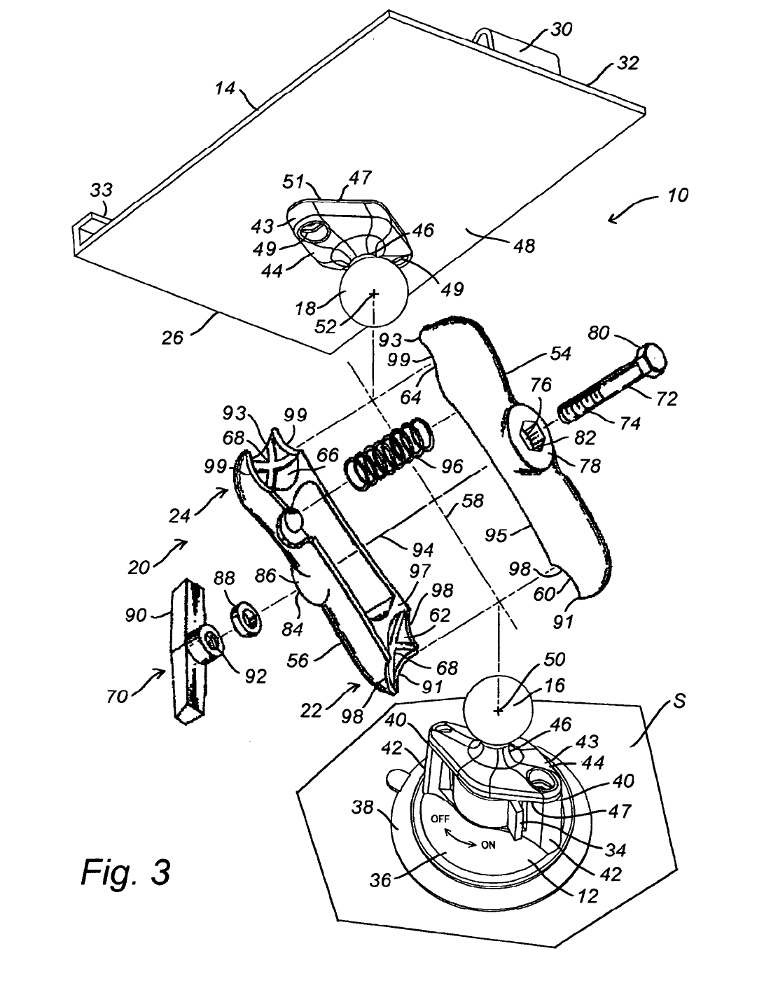

FIG. 3 is an assembly view of the universal detachable presentation bracket 10 of the invention. Here, the suction cup clamp 12 is embodied by example and without limitation as the suction cup clamp device having a compact axial suction cup installation and release mechanism 34 as disclosed in U.S. Pat. No. 6,666,420 issued to one of the inventors of the present invention on Dec. 23, 2003, which is incorporated herein by reference. Manual rotation in a first direction labeled “ON” of the axial suction cup installation and release mechanism 34 against a suction cup bell housing 36 activates a pliable suction cup 38 to securely attach to the selected substantially smooth and reasonably planar surface S.

Alternatively, other conventional suction cup clamp devices are also contemplated and may be substituted for the suction cup clamp device 12 without departing from the spirit and scope of the invention. For example, a suction cup clamp device using an over-center cam-type clamp mechanism for activating the pliable suction cup 38 may be substituted for the suction cup clamp 12 without departing from the spirit and scope of the invention.

The two part-spherical couplers 16 and 18 are formed of a resiliently deformable material having a substantially smooth part spherical outer surface, as disclosed by U.S. Pat. No. 5,885,845 for “Universally Positionable Mounting Device,” issued to the inventor of the present invention on Dec. 8, 1998, which is incorporated herein by reference.

The first part-spherical coupler 16 is securely coupled to a mounting surface 40 provided on the suction cup clamp 12. For example, a pair of spaced-apart mounting surfaces 40 are disposed on a mounting frame 42 shown as a pair of columns projected from the bell housing 36 on opposite sides of the axial suction cup installation and release mechanism 34. By example and without limitation, the first part-spherical coupler 16 is optionally formed directly on the mounting frame 42 of the suction cup mechanism 34. Alternatively, the first part-spherical coupler 16 is shown here being mounted on an intervening coupler bracket 43. The intervening coupler bracket 43 is illustrated here by example and without limitation as a flange 44, shown here by example and without limitation as a diamond-shaped flange, having a rigid stem 46 that is necked-down to be smaller than the part-spherical coupler 16, and a mounting platform 47 opposite from the necked-down stem 46. The first part-spherical coupler 16 is projected above the flange 44 on the necked-down stem 46 opposite from the mounting platform 47. The mounting platform 47 of the flange 44 is securely fastened or otherwise coupled to or integrated with the spaced-apart mounting surfaces 40 on the ends of the columns of the bell housing mounting frame 42. Alternatively, other conventional flange devices are also contemplated and may be substituted for the diamond-shaped flange 44 without departing from the spirit and scope of the invention. For example, a round flange device of the type illustrated in FIG. 1 may be substituted for the diamond-shaped flange 44 without departing from the spirit and scope of the invention.

The second part-spherical coupler 18 is shown here by example and without limitation as being projected on the necked-down stem 46 of another intervening coupler bracket 43. The flange 44 of this intervening coupler bracket 43 is securely attached to a back surface 48 of the board 26. By example and without limitation, the flange 44 is optionally formed integrally with the back surface 48 of the board 26, or molded in place. Alternatively, fasteners 49 attach the mounting platform 47 of the flange 44 to the back surface 48 of the board 26. The mounting platform 47 of the flange 44 is alternatively adhesively attached to the back surface 48 of the board 26 by means of a strong bi-adhesive tape 51, for example, a bi-adhesive tape disclosed by both Tarulli in U.S. Pat. No. 5,992,807 and Won in U.S. Pat. No. 6,149,116, which are both incorporated herein by reference.

The double-socket spacing mechanism 20 operates in conjunction with the two part-spherical couplers 16 and 18 to compose the mounting device for alternately providing relative motion and fixed positions between two relatively movable objects at selected angular orientations, as disclosed in U.S. Pat. No. 5,885,845, which is incorporated herein by reference. By example and without limitation, the first and second part-spherical couplers 16 and 18 are provided on the suction cup clamp 12 and clip board 14, respectively. The geometric centers of the first and second part-spherical couplers 16 and 18 define spaced first and second loci 50 and 52, respectively.

The double-socket spacing mechanism 20 is a split arm assembly having a pair of substantially identical relatively rigid arm sections 54 and 56 that are operatively juxtaposed to one another along a line of juncture 58 between the spaced loci 50, 52. Pairs of sockets 60, 62 and 64, 66 are formed in opposite ends of the rigid arm section 54, 56, respectively. The sockets 60, 62 and 64, 66 have interior surfaces shaped to substantially conform to the part spherical outer surface portion of the first and second part-spherical couplers 16 and 18. The interior surfaces of the sockets 60, 62 and 64, 66 are substantially smooth and rigid concave surfaces, wherein one or more of the smooth concave surfaces optionally includes one or more indentations 68 formed therein, e.g., crossed as shown.

The arm sections 54, 56 of the double-socket spacing mechanism 20 are clamped together relatively crosswise the line of juncture 58 in a plurality of clamped together positions, whereby the first and second pairs of sockets 60, 62 and 64, 66 are repositioned relative to the respective part-spherical couplers 16, 18 for sequentially forming each of the first loosely clamped state, the second partially clamped state, and the third fully clamped state. In the first loosely clamped state of the double-socket spacing mechanism 20 the first pair of sockets 60, 62 is joined with the outer surface of the first part-spherical coupler 16 to form the first relatively rotatable ball-and-socket joint 22 having a first sphere of revolution with a center at the center 50 of the first part-spherical coupler 16; and the second pair of sockets 64, 66 is loosely joined with the outer surface of the second part-spherical coupler 18 to form the second relatively rotatable ball-and-socket joint 24 having a first sphere of revolution with a center at the center 52 of the second part-spherical coupler 18. Thus, in the first loosely clamped state of the double-socket spacing mechanism 20 the arm sections 54, 56 are freely movable relative to both the suction cup clamp 12 and the clip board 14. Accordingly, within the range of the device the clip board 14 can be easily moved to any position and any orientation relative to the suction cup clamp 12 and the surface S to which it is securely attached.

In the second partially clamped state of the double-socket spacing mechanism 20 the first pair of sockets 60, 62 is securely interlocked with the outer surface of the first part-spherical coupler 16, while the second pair of sockets 64, 66 remains loosely joined with the outer surface of the second part-spherical coupler 18 to form the second relatively rotatable ball-and-socket joint 24 having a first sphere of revolution with a center at the center 52 of the second part-spherical coupler 18. Thus, in the second partially clamped state of the double-socket spacing mechanism 20 the arm sections 54, 56 are securely fixed in both position and orientation relative to the suction cup clamp 12. However, the clip board 14 remains freely movable relative to the arm sections 54, 56. Accordingly, within the range of the device the clip board 14 can be easily moved to any position and any spherical orientation relative to the arm sections 54, 56, the suction cup clamp 12 and the surface S.

In the third fully clamped state of the double-socket spacing mechanism 20 the first pair of sockets 60, 62 remain securely interlocked with the outer surface of the first part-spherical coupler 16, while the second pair of sockets 64, 66 is securely interlocked with the outer surface of the second part-spherical coupler 18. Thus, in the third fully clamped state of the double-socket spacing mechanism 20 the arm sections 54, 56 are securely fixed and substantially immovable in both position and orientation relative to arm sections 54, 56, the suction cup clamp 12 and the surface S.

The double-socket spacing mechanism 20 includes an adjustable clamping mechanism 70 for clamping the arm section 54, 56 and causing the opposing concave socket surfaces of the sockets 60, 62 and 64, 66 to assume different adjustment relationships to the respective first and second part-spherical couplers 16, 18 that apply differential clamping forces between the interior concave surfaces of the respective pairs of sockets 60, 62 and 64, 66. Accordingly, the clamping mechanism 70 is sequentially adjustable for clamping the arm section 54, 56 to different degrees for causing the double-socket spacing mechanism 20 to initially assume the first loosely clamped state for forming first and second relatively rotatable ball-and-socket joints 22, 24 with the two part-spherical couplers 16, 18; and for subsequently assuming each of the second partially clamped state for securely interlocking the spacing mechanism 20 with an outer surface of the first part-spherical coupler 16, while retaining the second relatively rotatable ball-and-socket joint 24 with the second part-spherical coupler 18; and the third fully clamped state for securely interlocking the spacing mechanism 20 with both of the two part-spherical couplers 16, 18. By example and without limitation, the adjustable clamping mechanism 70 is formed by a threaded bolt 72 having a threaded shaft 74 sized to pass through an aperture 76 formed through a boss 78 formed adjacent to a central portion the body of one arm section 54 (or 56). A head 80 of the bolt 72 nests in a socket 82 formed in the boss 78. The bolt's shaft 74 subsequently passes through a bore 84 through another boss 86 formed in a central portion the body of the other arm section 56 (or 54). A washer 88 is fitted over the bolt's shaft 74 adjacent to the boss 86. A handle or knob 90 with a threaded bore 92 is threadedly coupled to the bolt's shaft 74. Thereafter, tightening of the adjustable clamping mechanism 70 by turning the knob 90 along a drive axis 94 of the adjustable clamping mechanism 70 in a first direction onto the bolt's shaft 74 against the boss 86 adjusts first and second relatively spherically rotatable ball-and-socket joints 22, 24 relative to the two part-spherical couplers 16, 18 for sequentially forming each of the first loosely clamped state, the second partially clamped state, and the third fully clamped state wherein the spacing mechanism 20 is securely interlocked with both of the two part-spherical couplers 16, 18. Subsequent loosening of the adjustable clamping mechanism 70 by turning the knob 90 in reverse direction off of the bolt's shaft 74 and away from the boss 86 adjusts first and second relatively rotatable ball-and-socket joints 22, 24 relative to the two part-spherical couplers 16, 18 for retreating from the third fully clamped state for forming the second partially clamped state wherein the spacing mechanism 20 is securely interlocked with the outer surface of the first part-spherical coupler 16, while permitting the spacing mechanism 20 to form the second relatively rotatable ball-and-socket joint 24 with the second part-spherical coupler 18. Continued turning of the knob 90 in the reverse direction off of the bolt's shaft 74 and away from the boss 86 eventually adjusts the double-socket spacing mechanism 20 to achieve the first loosely clamped state for forming the first and second relatively rotatable ball-and-socket joints 22, 24 with each of the two part-spherical couplers 16, 18.

Alternatively, other conventional adjustable clamping mechanisms are also contemplated and may be substituted for the adjustable clamping mechanism 70 without departing from the spirit and scope of the invention. For example, an over-center cam-type clamp mechanism may be substituted for the threadedly adjustable clamping mechanism 70 without departing from the spirit and scope of the invention.

Optionally, the double socket spacing mechanism 20 may include a resilient differential biasing mechanism 96 positioned for differentially urging the two arm section 54, 56 apart from one another. The resilient differential biasing mechanism 96, for example, a conventional compression spring, is positioned between the two arm section 54, 56 at a location between the drive axis 94 of the adjustable clamping mechanism 70 and one of the ball-and-socket joints 22 or 24 (shown) adjacent to the end of the spacing mechanism 20. The differential biasing mechanism 96 operates to force the two arm section 54, 56 apart from one another at the nearer of the ball-and-socket joints 22 or 24 (shown), and simultaneously operates to force the two arm section 54, 56 toward one another at the farther of the ball-and-socket joints 24 or 22 (shown) by rotating or “rocking” the two arm section 54, 56 about the bolt 72 of the clamping mechanism 70 and the drive axis 94 thereof. Thus, the resilient biasing mechanism 96 generates a differential in the clamping forces between first and second pairs of sockets 60, 62 and 64, 66 vis-à-vis their respective part-spherical couplers 16 and 18. Accordingly, when the clamping mechanism 70 is partially engaged with the arm sections 54, 56 at the respective bosses 78, 86 thereof, the operation of the resilient biasing mechanism 96 causes the double-socket spacing mechanism 20 to enter the second partially clamped state by forcing together the arm section 54, 56 on the far side of the drive axis 94 for causing the first pair of sockets 60, 62 to engage and at least partially interlock with the outer surface of the first part-spherical coupler 16, while forcing apart the arm section 54, 56 on the near side of the drive axis 94 for the second pair of sockets 64, 66 to remain loosely joined with the outer surface of the second part-spherical coupler 18 to form the second relatively rotatable ball-and-socket joint 24.

Furthermore, the sockets 60, 62 and 64, 66 each have respective peripheral rims 91, 93 formed thereabout in the faces 95, 97 of the respective arm sections 54, 56 adjacent to their respective ends. The peripheral rims 91, 93 include one or more indentations 98, 99 in the outline of the respective sockets 60, 62 and 64, 66. The indentations 98, 99 are sized larger than the respective necks or stems 46 to pass there around. The indentations 98, 99 are formed as cooperating indentations positioned between the respective sockets 60, 62 and 64, 66 and are deep enough to permit the spacing mechanism 20 to be rotated about the center points or loci 50, 52 of the respective part-spherical couplers 16, 18 to angular orientations in which the line of juncture 58 can extend at right angles to the respective stems 46.

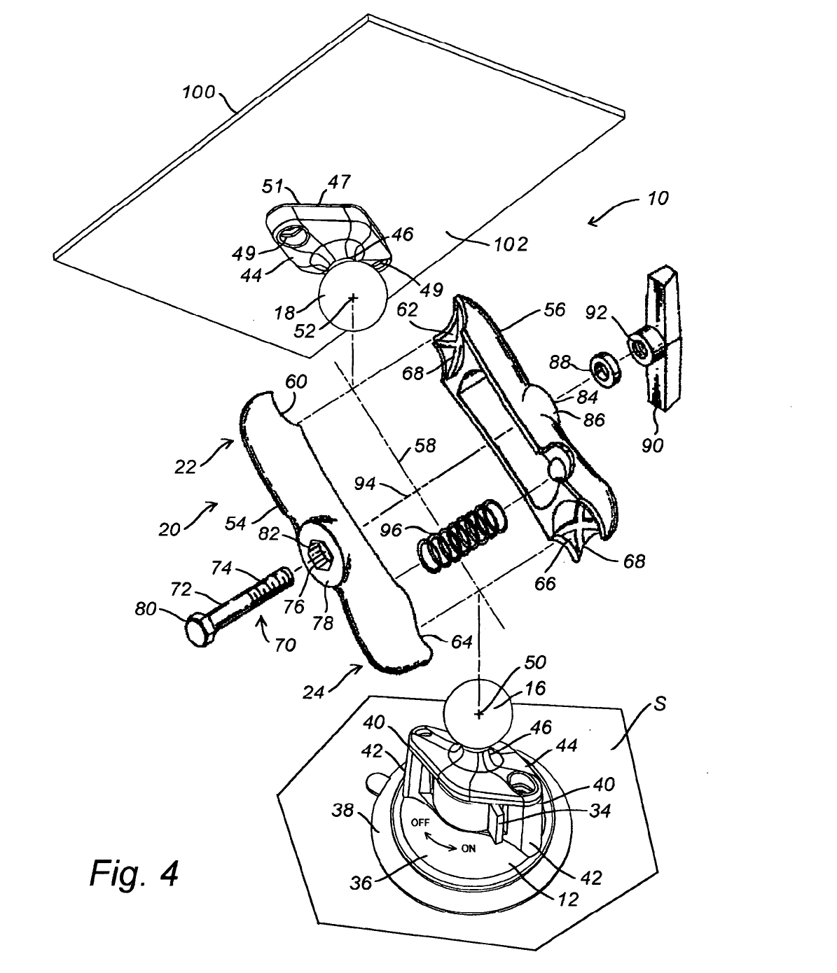

FIG. 4 is another assembly view of the universal detachable presentation bracket 10 of the invention. Here, the pair of substantially identical relatively rigid arm sections 54 and 6 of the double-socket spacing mechanism 20 are inverted relative to the suction cup clamp 12 and another device 110 that is substituted here for the supporting or retention device 14. By example and without limitation, the device 100 is a shaving or make-up mirror, or another useful device.

The second part spherical coupler 18 is shown hereby example and without limitation as being projected above another diamond-shaped flange 44 on another necked-down stem 46. The mounting platform 47 of the flange 44 is securely attached to a mounting surface 102 of the device 100 with the second part-spherical coupler 18 is projected above the flange 44 on the rigid stem 46. By example and without limitation the flange 44 is optionally formed integrally with the mounting surface 102 of the device 100, or molded in place. Alternatively, the fasteners 49 attach the mounting platform 47 of the flange 44 to the mounting surface 102 of the device 100. The mounting platform 47 of the flange 44 is alternatively adhesively attached to the mounting surface 102 of the device 100 by means of the bi-adhesive tape 51.

Here, the first pair of sockets 60, 62 is positioned to engage the second part-spherical coupler 18 and form the first relatively rotatable ball and socket joint 22 therewith. The second pair of sockets 64, 66 is positioned to engage the first part-spherical coupler 16 and form the second relatively rotatable ball-and-socket joint 24 therewith. Accordingly, operation of the adjustable clamping mechanism 70 on the arm section 54, 56 causes the opposing concave socket surfaces of the sockets 60, 62 and 64, 66 to instead assume the different adjustment relationships described herein with to the second and first part-spherical couplers 18 and 16, respectively.

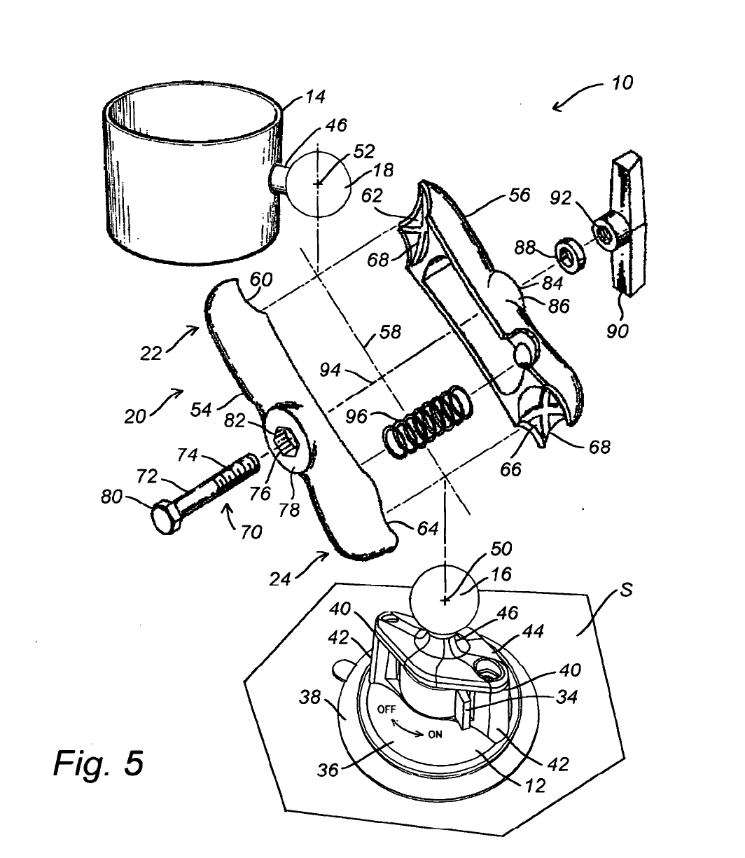

FIG. 5 illustrates the universal detachable presentation bracket 10 of the invention wherein the for the retention device 14 is further embodied as a caddy. Herein, the term “caddy” is defined according to Webster's Collegiate Dictionary, Tenth Edition, as a device for storing or holding objects when they are not in use. Accordingly, as used herein, the caddy is a generalized retention device. By example and without limitation the caddy retention device 14 is illustrated here a conventional cup-type holder for holding an individual serving can or bottle drink container for example as described in U.S. Pat. No. 4,596,370 “Container Holder” issued to George H. Adkins on Jun. 24, 1986, which is incorporated herein by reference. See, also, U.S. patent application Ser. No. 10/352,330; Publication Number 2004/0144904 “Universally

Positionable Platform For Beverage Holder” by the inventor of the instant application filed on Jan. 27, 2003 which is incorporated herein by reference. The universal detachable presentation bracket 10 of the invention provides positional adjustments of the caddy retention device 14 within a spherical coordinate frame by means of the two rotationally and spherically adjustable ball-and-socket components 22, 24 that are spaced apart on the single spacing mechanism 20.

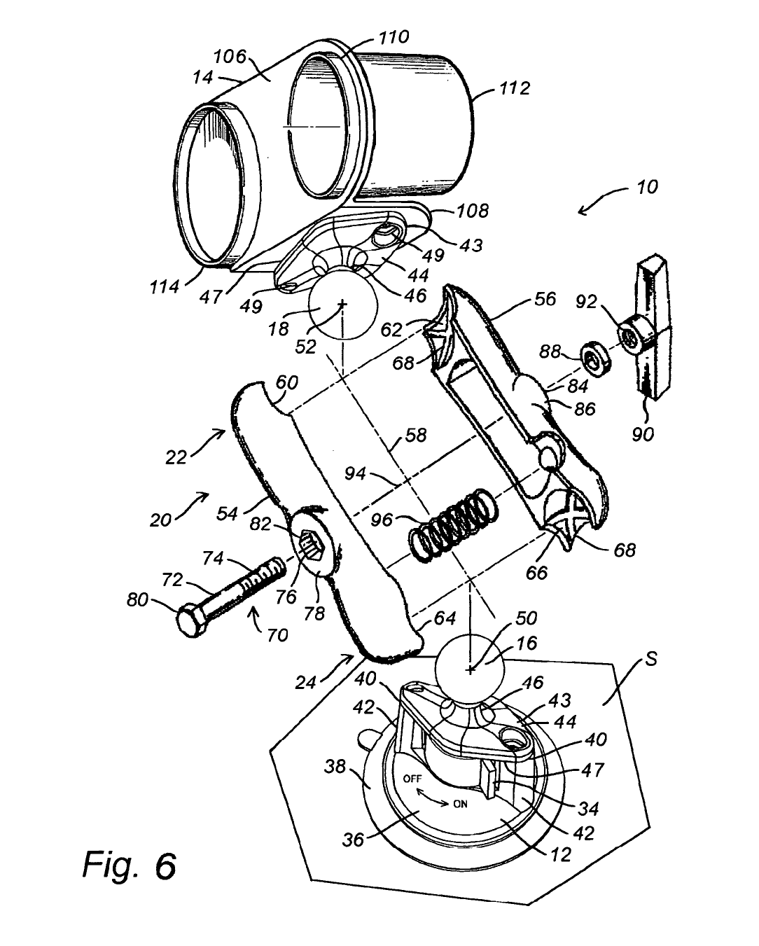

FIG. 6 illustrates the caddy retention device 14 being configured having a general accessory support bracket with the universal detachable presentation bracket 10 of the invention presenting the caddy retention device 14 in the vicinity of the selected surface S, where the selected surface S is shown for example as a generally vertical wall or window surface.

Obviously the selected surface S can be horizontal vertical or at any orientation in between because the universal detachable presentation bracket 10 of the invention presents the caddy retention device 14 in any spherical position at any rotational angle. By example and without limitation, the caddy retention device 14 is an accessory support bracket formed of a substantially rigid metal; plastic or polycarbonate frame having a frame 106 with a mounting flange 108 adjacent to one edge. The second part-spherical coupler 18 is optionally projected directly from the mounting flange 108 on the necked-down stem 46. Alternatively the second part-spherical coupler 18 is shown here as being presented on the intervening coupler bracket 43. Accordingly, the second part-spherical coupler 18 is projected from the coupler bracket's flange 44 on the necked-down stem 46, and the mounting flange 108 of the caddy retention device 14 is securely attached to the mounting platform 47 of the flange 44.

The caddy's frame 106 is optionally structured to operate as a drink container holder. For example, a round aperture 110 is provided in the frame 106 that is sized to receive a conventional individual serving can or bottle drink container. Alternatively, as illustrated here by example and without limitation the caddy's frame 106 is equipped with a cup-type holder 112 that is structured for holding an individual serving can or bottle drink container, for example as described in U.S. Pat. No. 4,596,370, or in U.S. patent application Ser. No. 10/352,330, Publication No. 2004/0144904, which are both incorporated herein by reference.

The caddy's frame 106 is optionally structured to include a small tray 114 of a type that is suitable for holding small amounts of different items, such as candies, nuts or other snacks that may be desirable to person using the universal detachable presentation bracket 10 of the invention. Alternatively, the small tray 114 is configured as an ash tray for holding one or more matches, cigarettes, cigars or pipes and ashes generated thereby.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

1: A universal detachable presentation bracket that provides positional adjustments within a spherical coordinate frame, the bracket comprising:
two releasably interlockable rotationally and spherically rotatable ball-and-socket components formed between a substantially rigid spacing component and two part-spherical couplers;
a suction cup clamp mechanism being coupled to one of the two part-spherical couplers; and
an attached device being coupled to a different one of the two part-spherical couplers.

2: The presentation bracket of claim 1 wherein at least a first one of the two part-spherical couplers further comprises a resiliently deformable material having a substantially smooth part spherical outer surface.

3: The presentation bracket of claim 2 wherein the spacing component further comprises two substantially rigid arm sections forming two pairs of sockets therebetween, at least a first pair of the two pairs of sockets having substantially smooth and rigid concave interior surfaces shaped to substantially conform to the part spherical outer surface portion of the first resiliently deformable part-spherical coupler.

4: The presentation bracket of claim 3 further comprising an adjustable clamping mechanism operable between the two substantially rigid arm sections for urging the substantially smooth and rigid concave interior surfaces of the first pair of sockets to form a first one of the rotationally and spherically rotatable ball-and-socket components with the first resiliently deformable part-spherical coupler and being further operable between the two substantially rigid arm sections for urging the substantially smooth and rigid concave interior surfaces of the first pair of sockets to releasably interlock with the outer surface of the first resiliently deformable part-spherical coupler.

5: The presentation bracket of claim 4 wherein a second one of the two part-spherical couplers further comprises a resiliently deformable material having a substantially smooth part spherical outer surface;
a second pair of the two pairs of sockets formed between substantially rigid arm sections further comprises substantially smooth and rigid concave interior surfaces shaped to substantially conform to the part spherical outer surface portion of the second resiliently deformable part-spherical coupler, and
the adjustable clamping mechanism is further operable between the two substantially rigid arm sections for urging the substantially smooth and rigid concave interior surfaces of the second pair of sockets to form a second one of the rotationally and spherically rotatable ball-and-socket components with the second resiliently deformable part-spherical coupler, and being further operable between the two substantially rigid arm sections for urging the substantially smooth and rigid concave interior surfaces of the second pair of sockets to releasably interlock with the outer surface of the second resiliently deformable part-spherical coupler.

6: The presentation bracket of claim 5, further comprising a differential biasing mechanism coupled for differentially urging apart one of the first and second pairs of sockets, and further coupled for urging together a different one of the first and second pairs of sockets.

7: The presentation bracket of claim 5 wherein the attached device further comprises an attached retention device.

8: The presentation bracket of claim 7, further comprising a coupler bracket intervening between the attached device and the part-spherical coupler, the intervening coupler bracket comprising a flange having a rigid stem projected from a first surface thereof and being necked-down to be smaller than the part-spherical coupler, and a mounting platform formed on a second surface thereof opposite from the stem, the part-spherical coupler being coupled to the stem in a position spaced away from the flange.

9: The presentation bracket of claim 7 wherein the attached retention device further comprises an attached caddy device.

10: A universal detachable presentation bracket that provides positional adjustments of an attached device within a spherical coordinate frame, the presentation bracket comprising:
first and second part-spherical couplers each formed of a resiliently deformable material having a substantially smooth part spherical outer surface and being projected from a flange on a substantially rigid stem;
a substantially rigid spacing component formed of a pair of substantially rigid arm sections forming first and second pairs of sockets adjacent to opposite ends thereof, each of the first and second pairs of arm sections being formed with substantially smooth and rigid concave interior surfaces shaped to substantially conform to the part spherical outer surface portion of the respective first and second resiliently deformable part-spherical couplers;
a differential biasing mechanism coupled between the arm sections of the spacing component for differentially urging apart one of the first and second pairs of sockets, and simultaneously urging together a different one of the first and second pairs of sockets;
an adjustable clamping mechanism operable with the spacing component for urging the first and second pairs of sockets of the two substantially rigid arm sections into each of three sequential adjustment relationships to the respective first and second part-spherical couplers, the three sequential adjustment relationships comprising:
a first loosely clamped relationship forming first and second relatively rotatable ball-and-socket joints between the first and second pairs of sockets and the part spherical outer surface portions of the respective first and second part-spherical couplers,
a second partially clamped relationship securely interlocking the first pair of sockets with the part spherical outer surface portion of the first part-spherical coupler, while retaining the second relatively rotatable ball-and-socket joint between the second pair of sockets and the part spherical outer surface portions of the second part-spherical coupler, and
a third fully clamped relationship securely interlocking the first and second pairs of sockets with the part spherical outer surface portions of the respective first and second part-spherical couplers;
a suction cup clamp mechanism having a frame coupled to one of the two part-spherical couplers; and
a retention device having a portion coupled to a different one of the two part-spherical couplers.

11: A method for positionally adjusting a universal detachable presentation bracket within a spherical coordinate frame, the method comprising:
providing two releasably interlockable rotationally and spherically rotatable ball-and-socket components between a substantially rigid spacing component and two part-spherical couplers;
coupling a suction cup clamp mechanism to one of the two part-spherical couplers;
coupling a device to a different one of the two part-spherical couplers;
spherically rotating one or both of the two part-spherical couplers relative to the substantially rigid spacing component for spherically and rotationally adjusting a position and orientation of the device relative to the suction cup clamp mechanism; and
subsequently releasably interlocking both of the two ball-and-socket components.

12: The method of claim 11, further comprising forming at least a first one of the two part-spherical couplers of a resiliently deformable material having a substantially smooth part spherical outer surface.

13: The method of claim 12 wherein providing two releasably interlockable rotationally and spherically rotatable ball-and-socket components between a substantially rigid spacing component and two part-spherical couplers further comprises forming two pairs of sockets between two substantially rigid arm sections, including forming at least a first pair of the two pairs of sockets with substantially smooth and rigid concave interior surfaces shaped to substantially conform to the part spherical outer surface portion of the first resiliently deformable part-spherical coupler.

14: The method of claim 13, further comprising operating an adjustable clamping mechanism between the two substantially rigid arm sections for initially urging the substantially smooth and rigid concave interior surfaces of the first pair of sockets to form a first one of the rotationally and spherically rotatable ball-and-socket components with the first resiliently deformable part-spherical coupler, and further operating the adjustable clamping mechanism between the two substantially rigid arm sections for subsequently urging the substantially smooth and rigid concave interior surfaces of the first pair of sockets to releasably interlock with the outer surface of the first resiliently deformable part-spherical coupler.

15: The method of claim 14, further comprising forming a second one of the two part-spherical couplers of a resiliently deformable material having a substantially smooth part spherical outer surface; and
wherein: forming two pairs of sockets between two substantially rigid arm sections further comprises forming a second pair of the two pairs of sockets with substantially smooth and rigid concave interior surfaces shaped to substantially conform to the part spherical outer surface portion of the second resiliently deformable part-spherical coupler; and
operating an adjustable clamping mechanism between the two substantially rigid arm sections further comprises operating the adjustable clamping mechanism for urging the substantially smooth and rigid concave interior surfaces of the second pair of sockets to form a second one of the rotationally and spherically rotatable ball-and-socket components with the second resiliently deformable part-spherical coupler, and further operating the adjustable clamping mechanism between the two substantially rigid arm sections for urging the substantially smooth and rigid concave interior surfaces of the second pair of sockets to releasably interlock with the outer surface of the second resiliently deformable part-spherical coupler.

16: The method of claim 15, further comprising differentially urging apart one of the first and second pairs of sockets, and substantially simultaneously urging together a different one of the first and second pairs of sockets.

17: The method of claim 15 wherein coupling a device to a different one of the two part-spherical couplers further comprises coupling a retention device.

18: A method for positionally adjusting a universal detachable presentation bracket within a spherical coordinate frame, the method comprising:
rigidly projecting one of two part-spherical couplers from a suction cup clamp mechanism;
rigidly projecting a different one of the two part-spherical couplers from a retention device;
forming two rotationally and spherically rotatable ball-and-socket components between the two part-spherical couplers and two corresponding pairs of complementary sockets adjacent to opposite ends of a substantially rigid spacing component;
spherically rotating one or both of the two part-spherical couplers within the two corresponding pairs of complementary sockets relative to the substantially rigid spacing component for spherically and rotationally adjusting a relative position and orientation of the clip board to the suction cup clamp mechanism; and
subsequently immobilizing both of the two ball-and-socket components.

19: The method of claim 18, further comprising forming the two part-spherical couplers of a resiliently deformable material having a substantially smooth part spherical outer surface; and
forming the two pairs of complementary sockets having substantially smooth and rigid concave interior surfaces shaped to substantially conform to the part spherical outer surface portion of the corresponding resiliently deformable part-spherical coupler.

20: The method of claim 19, further comprising clamping together the two pairs of complementary sockets in an initial relationship with the two corresponding part-spherical couplers wherein the two rotationally and spherically rotatable ball-and-socket components are formed therebetween, and a final relationship wherein both of the two ball-and-socket components are relatively immobilized.

21: The method of claim 20, further comprising clamping together the two pairs of complementary sockets in an intermediate relationship with the two corresponding part-spherical couplers wherein one of the two rotationally and spherically rotatable ball-and-socket components is formed therebetween, and a different one of the two ball-and-socket components is relatively immobilized.

22: The method of claim 21, further comprising differentially urging apart one of the two pairs of complementary sockets, and substantially simultaneously urging together a different one of the two ball-and-socket components.

23: A method for positionally adjusting a universal detachable presentation bracket within a spherical coordinate frame, the method comprising:
on respective substantially rigid neck portions, projecting each of two part-spherical couplers from respective flange members;
coupling the flange member of one of the two part-spherical couplers to a suction cup clamp mechanism;
coupling the suction cup clamp mechanism to a substantially smooth external surface;
coupling the flange member of a different one of the two part-spherical couplers to a support member;
in opposite ends of a substantially rigid spacing component, forming pairs of sockets complementary to respective ones of the two part-spherical couplers;
operating an adjustable clamping mechanism for forming respective rotationally and spherically rotatable ball-and-socket components between the two part-spherical couplers and respective ones of the two pairs of complementary sockets;
spherically rotating one or both of the two part-spherical couplers within the two corresponding pairs of complementary sockets relative to the substantially rigid spacing component for spherically and rotationally adjusting a position and orientation of the support member relative to the suction cup clamp mechanism; and
subsequently operating the adjustable clamping mechanism for immobilizing both of the two ball-and-socket components.

24: The method of claim 23, further comprising operating the adjustable clamping mechanism for forming one of the rotationally and spherically rotatable ball-and-socket components between one of the two part-spherical couplers and the respective one of the two pairs of complementary sockets, and substantially simultaneously operating the adjustable clamping mechanism for immobilizing a different one of the two ball-and-socket components.

25: The method of claim 24, further comprising forming each of the two part-spherical couplers of a resiliently deformable material having a substantially smooth part spherical outer surface; and
wherein forming pairs of sockets complementary to respective ones of the two part-spherical couplers further comprises forming the two pairs of complementary sockets having substantially smooth and rigid concave interior surfaces shaped to substantially conform to the part spherical outer surface portion of a corresponding one of the resiliently deformable part-spherical couplers.

26: The method of claim 25, further comprising positioning a resilient differential biasing mechanism for differentially urging apart one of the two pairs of complementary sockets, and substantially simultaneously urging together a different one of the two ball-and-socket components.

27: The method of claim 25, further comprising supporting one or more papers on the support member.
